(19) United States
(12) Patent Application Publication
(10) Pub. No.: US 2026/0157254 A1
(43) Pub. Date: Jun. 11, 2026

(54) SHOVEL WITH MULTIPLE SPACED-APART GRIPS

(71) Applicant: Shawn Hanson, Sitka, AK (US)

(72) Inventor: Shawn Hanson, Sitka, AK (US)

(21) Appl. No.: 18/969,492

(22) Filed: Dec. 5, 2024

(51) Int. Cl. A01B 1/02

(52) U.S. Cl. CPC A01B 1/026

(57) ABSTRACT

A shovel for facilitating scooping materials with ergonomically positioned hands includes a first handlebar which has a grip end and an attachment end. The first handlebar has a curvature such that the first handlebar is not linear. A back side of the first handlebar is convex along the curvature, and a front side of the first handlebar is concave along the curvature. The first handlebar defines a first grip adjacent to the grip end. A scoop blade is mounted to the attachment end of the first handlebar. The scoop blade has a proximal edge and a distal edge with respect to the first handlebar. A second handlebar is coupled to the first handlebar. The second handlebar defines a second grip which is spaced forwardly from the first handlebar proximate to the scoop blade.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to shovels and more particularly pertains to a new shovel for facilitating scooping materials with ergonomically positioned hands.

### (2) Description of Related Art Including Information Disclosed Under 37 CFR 1.97 and 1.98

Various shovels are disclosed by the prior art which have a first grip positioned distally from a scoop blade of the shovel and a second grip positioned proximate to and above the scoop blade. However, the prior art fails to describe such a shovel in which a first handlebar which defines the first grip is curved to further ergonomically position the first grip and which a second handlebar which defines the second grip extends from a front surface of the first handlebar generally toward the scoop blade. Such a shovel provides for advantages in manufacturing and strength not found in the shovels of the prior art.

### (h) BRIEF SUMMARY OF THE INVENTION

An embodiment of the disclosure meets the needs presented above by generally comprising a first handlebar which has a grip end and an attachment end. The first handlebar has a curvature such that the first handlebar is not linear. A back side of the first handlebar is convex along the curvature, and a front side of the first handlebar is concave along the curvature. The first handlebar defines a first grip adjacent to the grip end. A scoop blade is mounted to the attachment end of the first handlebar. The scoop blade has a proximal edge and a distal edge with respect to the first handlebar. A second handlebar is coupled to the first handlebar. The second handlebar defines a second grip which is spaced forwardly from the first handlebar proximate to the scoop blade.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a shovel according to an embodiment of the disclosure.

FIG. 2 is a perspective view of another embodiment of the disclosure.

FIG. 3 is a side view of the embodiment of the disclosure shown in FIG. 1.

FIG. 4 is an in-use view of the embodiment of the disclosure shown in FIG. 1.

### DETAILED DESCRIPTION OF THE INVENTION

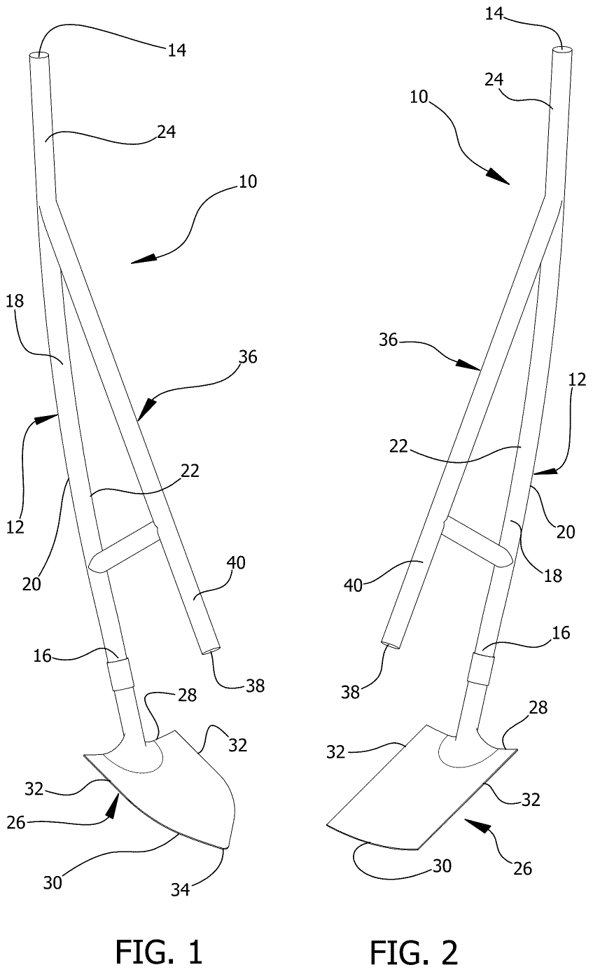

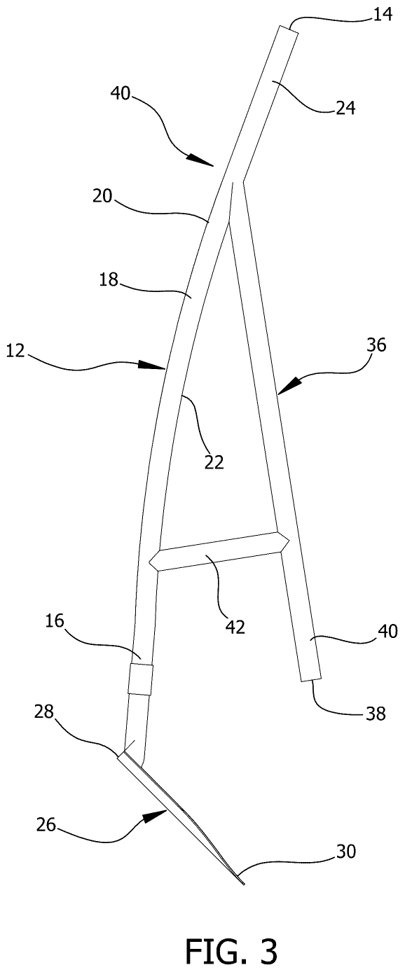

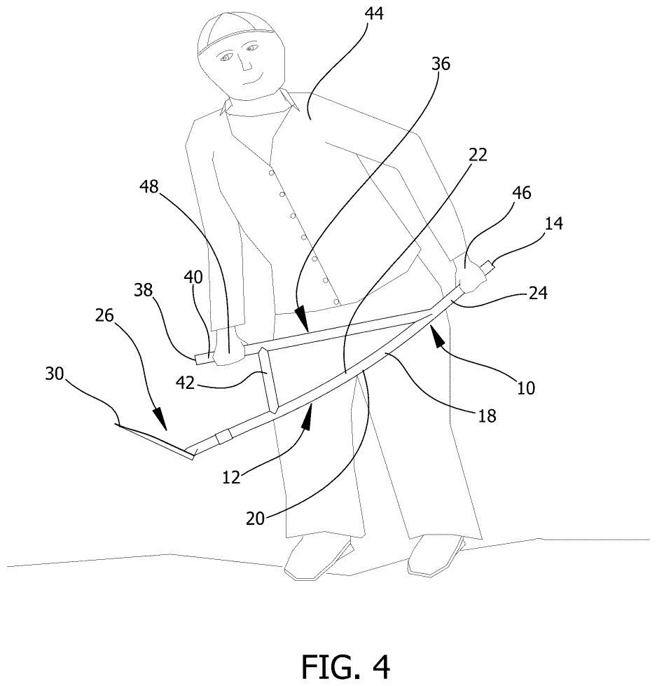

With reference now to the drawings, and in particular to FIGS. 1 through 4 thereof, a new shovel embodying the principles and concepts of an embodiment of the disclosure and generally designated by the reference numeral 10 will be described.

As best illustrated in FIGS. 1 through 4, the shovel 10 generally comprises a first handlebar 12 which has a grip end 14 and an attachment end 16. The first handlebar 12 has a curvature 18 such that the first handlebar 12 is not linear. A back side 20 of the first handlebar 12 is convex along the curvature 18, and a front side 22 of the first handlebar 12 is concave along the curvature 18. The first handlebar 12 defines a first grip 24 which extends between the grip end 14 and the curvature 18 and is linear. A scoop blade 26 is mounted to the attachment end 16 of the first handlebar 12. The scoop blade 26 has a proximal edge 28 and a distal edge 30 with respect to the first handlebar 12. The scoop blade 26 is oriented to extend from the proximal edge 28 to the distal edge 30 at an obtuse angle from the front side 22 of the first handlebar 12.

A second handlebar 36 is coupled to the first handlebar 12. The second handlebar 36 is elongated and extends from the junction of the curvature 18 and the first grip 24 of the first handlebar 12 to a distal end 38 with respect to the first handlebar 12, forming an acute angle with the front side 22 of the first handlebar 12. A distal portion of the second handlebar 36 with respect to the first handlebar 12 defines a second grip 40. The second grip 40 is spaced forwardly from the first handlebar 12 proximate to the scoop blade 26. A support bar 42 is coupled to and extends between the first handlebar 12 and the second handlebar 36. The support bar 42 is positioned adjacent to the second grip 40 of the second handlebar 36.

With reference to FIGS. 1, 3, and 4, an embodiment is shown in which the distal edge 30 of the scoop blade 26 tapers to a point 34. FIG. 2 shows another embodiment wherein the scoop blade 26 has a pair of lateral edges 32, each of which extends between the proximal edge 28 and the distal edge 30, and the distal edge 30 is perpendicular to the pair of lateral edges 32. The scoop blade 26 may have any of a variety of shapes suitable for scooping soil or other matter.

In use, a user 44 may grasp the first grip 24 with a first hand 46 of the user 44 and grasp the second grip 40 with a second hand 48 of the user 44. So grasped, the shovel 10 may be used by the user 44 to displace soil or other matter by scooping the matter and dumping it in a new location. The second grip 40 is positioned such that it would be spaced generally above the scoop handle while scooping matter, thus facilitating the user 44 in lifting the matter without needing to stoop as low as in the use of other shovels where only one handlebar extends from a rear side of its scooping blade. The second grip 40 is also positioned closer to the scoop blade 26 than the grip end 14 of the first handlebar 12 such that strain from lifting soil is decreased due to less torque being applied to the second grip 40. The orientations of the first grip 24 and the second grip 40 allow for the first hand 46 and the second hand 48 to be ergonomically positioned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shovel comprising:
a first handlebar, the first handlebar having a grip end and an attachment end, the first handlebar having a curvature such that the first handlebar is not linear, a back side of the first handlebar being convex along the curvature, a front side of the first handlebar being concave along the curvature, the first handlebar defining a first grip adjacent to the grip end;
a scoop blade mounted to the attachment end of the first handlebar, the scoop blade having a proximal edge and a distal edge with respect to the first handlebar; and
a second handlebar coupled to the first handlebar, the second handlebar defining a second grip which is spaced forwardly from the first handlebar proximate to the scoop blade.

2. The shovel of claim 1, wherein the scoop blade is oriented to extend from the proximal edge to the distal edge at an obtuse angle from the front side of the first handlebar.

3. The shovel of claim 1, wherein the first grip extends between the grip end and the curvature, the first grip being linear.

4. The shovel of claim 3, wherein the second handlebar is elongated, the second handlebar extending from the junction of the curvature and the first grip of the first handlebar to a distal end with respect to the first handlebar, a distal portion of the second handlebar with respect to the first handlebar defining the second grip.

5. The shovel of claim 4, wherein the second handlebar forms an acute angle with the curved section of the first handlebar.

6. The shovel of claim 4, further comprising a support bar being coupled to and extending between the first handlebar and the second handlebar.

7. The shovel of claim 6, wherein the support bar is positioned adjacent to the second grip of the second handlebar.

8. The shovel of claim 1, wherein the distal edge of the scoop blade tapers to a point.

9. The shovel of claim 1, wherein the scoop blade has a pair of lateral edges, each lateral edge of the pair of lateral edges extending between the proximal edge and the distal edge, the distal edge being perpendicular to the pair of lateral edges.

10. A shovel comprising:
a first handlebar, the first handlebar having a grip end and an attachment end, the first handlebar having a curvature such that the first handlebar is not linear, a back side of the first handlebar being convex along the curvature, a front side of the first handlebar being concave along the curvature, the first handlebar defining a first grip adjacent to the grip end, the first grip extending between the grip end and the curvature, the first grip being linear;
a scoop blade mounted to the attachment end of the first handlebar, the scoop blade having a proximal edge and a distal edge with respect to the first handlebar, the scoop blade being oriented to extend from the proximal edge to the distal edge at an obtuse angle from the front side of the first handlebar;
a second handlebar coupled to the first handlebar, the second handlebar being elongated, the second handlebar extending from the junction of the curvature and the first grip of the first handlebar to a distal end with respect to the first handlebar, a distal portion of the second handlebar with respect to the first handlebar defining a second grip, the second grip being spaced forwardly from the first handlebar proximate to the scoop blade, the second handlebar forming an acute angle with the front side of the first handlebar; and
a support bar being coupled to and extending between the first handlebar and the second handlebar, the support bar being positioned adjacent to the second grip of the second handlebar.

10. The shovel of claim 9, wherein the distal edge of the scoop blade tapers to a point.

11. The shovel of claim 9, wherein the scoop blade has a pair of lateral edges, each lateral edge of the pair of lateral edges extending between the proximal edge and the distal edge, the distal edge being perpendicular to the pair of lateral edges.
